(19) United States
(12) Patent Application Publication
(10) Pub. No.: US 2026/0280368 A1
(43) Pub. Date: Sep. 17, 2026

(54) ROTATING ELECTRICAL MACHINE WITH HIGH EFFICIENCY, HIGH TORQUE DENSITY, AND REDUCED USAGE OF RARE METALS

(71) Applicant: Panasonic Intellectual Property Management Co., Ltd., Osaka (JP)

(72) Inventors: Takehiko YAMAKAWA, Osaka (JP); Kazuyuki SAKIYAMA, Osaka (JP); Daiki TANAKA, Osaka (JP); Tsutomu SAKATA, Osaka (JP)

(21) Appl. No.: 19/131,413

(22) PCT Filed: Nov. 16, 2023
(86) PCT No.: PCT/JP2023/041269

§ 371 Date: May 20, 2025

(30) Foreign Application Priority Data
Nov. 22, 2022 (JP) 2022-186593
Oct. 27, 2023 (JP) 2023-184825

(51) Int. Cl. H02K 1/276; H02K 1/02; H02K 1/14; H02K 15/022; H02K 15/0273; H02K 15/085

(52) U.S. Cl. CPC H02K 1/2766; H02K 1/02; H02K 1/145; H02K 15/022; H02K 15/0273; H02K 15/085

(57) ABSTRACT

Please replace the abstract in the specification as filed with the below paragraph as follows:

A motor is provided with: an inner core and an outer core formed to be relatively rotatable with respect to each other about a common rotating shaft; magnets provided in the inner core; and windings wound around the outer core. The inner core includes a plurality of magnetic material portions made of a plurality of magnetic materials having magnetic characteristics different from each other, respectively, in a cross section perpendicular to the rotating shaft.

### TECHNICAL FIELD

The present disclosure relates to a rotating electrical machine and a method of manufacturing the same.

### BACKGROUND ART

Rotating electrical machines, such as motors or generators, are required to have a high efficiency, and also to have a high torque or a high torque density.

For example, Patent Document 1 discloses a rotor core for an interior permanent magnet (IPM) motor, as an iron core including multilayered steel sheets, each sheet having three-layer structure of a surface layer, an inner layer, and a surface layer in its thickness direction, the surface layers being made of a ferromagnetic material, and the inner layer being made of a nonmagnetic material. Using different magnetic materials in the thickness direction of the steel sheets results in a rotor core material for an IPM motor, and a rotor core for an IPM motor, with a good motor efficiency, and a good balance between strength and iron loss.

In addition, Patent Document 2 discloses a magnet-embedded motor in which a saturation magnetic flux density of a magnetic material of a rotor core is higher than that of a magnetic material of a stator core by 0.2 T or more. Here, the magnetic material of the rotor core is, for example, permendur, and the magnetic material of the stator core is, for example, an amorphous soft magnetic material. Using permendur having a high saturation magnetic flux density in the rotor core results in an improved torque and a reduced counter electromotive voltage.

### CITATION LIST

### Patent Documents

PATENT DOCUMENT 1: Japanese Patent No. JP 5272713 B2
PATENT DOCUMENT 2: Japanese Patent Laid-open Publication No. JP 2021-048675 A

### SUMMARY OF INVENTION

### Technical Problem

Since the rotor core of Patent Document 1 contains magnetic materials having different magnetic characteristics, magnetic flux tends to flow to a magnetic material having a higher magnetic permeability. Therefore, the magnetic flux flows not only in directions along surfaces of the steel sheets, but also flows in the thickness direction. As a result, an eddy current loss in the core increases, and the efficiency decreases, as compared with the case of using typical non-oriented electrical steel sheets, and full effects are not obtained even when combining different magnetic materials. Therefore, it is required to provide a motor having a higher efficiency and a higher torque density than the prior art.

Permendur used in the motor of Patent Document 2 has a high saturation magnetic flux density, but contains a large amount of cobalt, which is an expensive rare metal. In general, permendur is used in limited applications, such as aircraft and racing cars, due to its cost, and it is not practical to use permendur in industrial applications. Therefore, it is required to reduce usage of expensive materials including rare metals as much as possible.

An object of the present disclosure is to provide a rotating electrical machine having a higher efficiency and a higher torque density than the prior art, while reducing usage of expensive materials including rare metals as much as possible, and provide a method of manufacturing such a rotating electrical machine.

### Solution to Problem

A rotating electrical machine according to one aspect of the present disclosure is provided with: a first magnetic core and a second magnetic core formed to be relatively rotatable with respect to each other about a common rotating shaft; a plurality of magnets provided in the first magnetic core; and a plurality of windings wound around the second magnetic core. At least one of the first magnetic core and the second magnetic core includes a plurality of magnetic material portions made of a plurality of magnetic materials having magnetic characteristics different from each other, respectively, in a cross section perpendicular to the rotating shaft.

### Advantageous Effects of Invention

According to one aspect of the present disclosure, it is possible to provide a rotating electrical machine having a higher efficiency and a higher torque density than the prior art, while reducing usage of expensive materials including rare metals as much as possible.

### BRIEF DESCRIPTION OF DRAWINGS

FIG. 1 is a vertical cross-sectional view showing a configuration of a motor 101 according to a first embodiment.

FIG. 2 is a transverse cross-sectional view showing the configuration of the motor 101 according to the first embodiment.

FIG. 3A is a view showing a first step of manufacturing a rotor 102 of FIG. 2.

FIG. 3B is a view showing a second step of manufacturing the rotor 102 of FIG. 2.

FIG. 3C is a view showing a third step of manufacturing the rotor 102 of FIG. 2.

FIG. 3D is a view showing a fourth step of manufacturing the rotor 102 of FIG. 2.

FIG. 4 is a view showing a first jointing method of a yoke 111 and a high saturation magnetic flux density portion 112 of FIG. 2.

FIG. 5 is a view showing a second jointing method of the yoke 111 and the high saturation magnetic flux density portion 112 of FIG. 2.

FIG. 6 is a view showing a third jointing method of the yoke 111 and the high saturation magnetic flux density portion 112 of FIG. 2.

FIG. 7 is a transverse cross-sectional view showing a configuration of a motor 101A according to a first modified embodiment of the first embodiment.

FIG. 8A is a view showing a first step of manufacturing a rotor 102A of FIG. 7.

FIG. 8B is a view showing a second step of manufacturing the rotor 102A of FIG. 7.

FIG. 8C is a view showing a third step of manufacturing the rotor 102A of FIG. 7.

FIG. 9 is a transverse cross-sectional view showing a configuration of a motor 101B according to a second modified embodiment of the first embodiment.

FIG. 10 is a transverse cross-sectional view showing a configuration of a motor 101C according to a third modified embodiment of the first embodiment.

FIG. 11A is a view showing a first step of manufacturing a stator 103C of FIG. 10.

FIG. 11B is a view showing a second step of manufacturing the stator 103C of FIG. 10.

FIG. 11C is a view showing a third step of manufacturing the stator 103C of FIG. 10.

FIG. 11D is a view showing a fourth step of manufacturing the stator 103C of FIG. 10.

FIG. 12 is a view showing another jointing method of a protrusion 122C and a high saturation magnetic flux density portion 124 of FIG. 10.

FIG. 13 is a transverse cross-sectional view showing a configuration of a motor 101D according to a second embodiment.

FIG. 14 is a graph showing magnetization characteristics of magnetic materials used in the motor of FIG. 13.

FIG. 15 is a graph showing iron loss characteristics of magnetic materials used in the motor of FIG. 13.

FIG. 16 is a transverse cross-sectional view showing a configuration of a motor 101E according to a first modified embodiment of the second embodiment.

FIG. 17 is a transverse cross-sectional view showing a configuration of a motor 101F according to a second modified embodiment of the second embodiment.

FIG. 18 is a transverse cross-sectional view showing a configuration of a motor 101G according to a third modified embodiment of the second embodiment.

FIG. 19 is a transverse cross-sectional view showing a configuration of a motor 101H according to a third embodiment.

FIG. 20 is a transverse cross-sectional view showing a configuration of a motor 101I according to a fourth embodiment.

FIG. 21 is a transverse cross-sectional view showing a configuration of a motor 101J according to a fifth embodiment.

FIG. 22 is a transverse cross-sectional view showing a configuration of a motor 101K according to a sixth embodiment.

FIG. 23 is a view showing a detailed configuration of a protrusion 122K of FIG. 22.

FIG. 24 is a view showing a detailed configuration of a protrusion 122Ka according to a first modified embodiment of the sixth embodiment.

FIG. 25 is a view showing a detailed configuration of a protrusion 122Kb according to a second modified embodiment of the sixth embodiment.

FIG. 26 is a view showing a detailed configuration of a protrusion 122Kc according to a third modified embodiment of the sixth embodiment.

FIG. 27 is a view showing a detailed configuration of a protrusion 122Kd according to a fourth modified embodiment of the sixth embodiment.

FIG. 28 is a graph showing a change in content rate of a high saturation magnetic flux density material with respect to positions along line A-A′ of FIG. 27.

FIG. 29 is a graph showing a change in content rate of the high saturation magnetic flux density material with respect to positions along line B-B′ of FIG. 27.

FIG. 30 is a view showing a configuration of a part of a motor manufacturing apparatus according to a seventh embodiment.

### DESCRIPTION OF EMBODIMENTS

Hereinafter, rotating electrical machines and methods of manufacturing the same according to embodiments of the present disclosure will be described with reference to the drawings. It should be noted that each configuration described below is a mere example of the present disclosure, the present disclosure is not limited to the following embodiments, and besides these embodiments, various modifications can be made depending on designs or the like, without departing from the technical idea of the present disclosure.

### First Embodiment

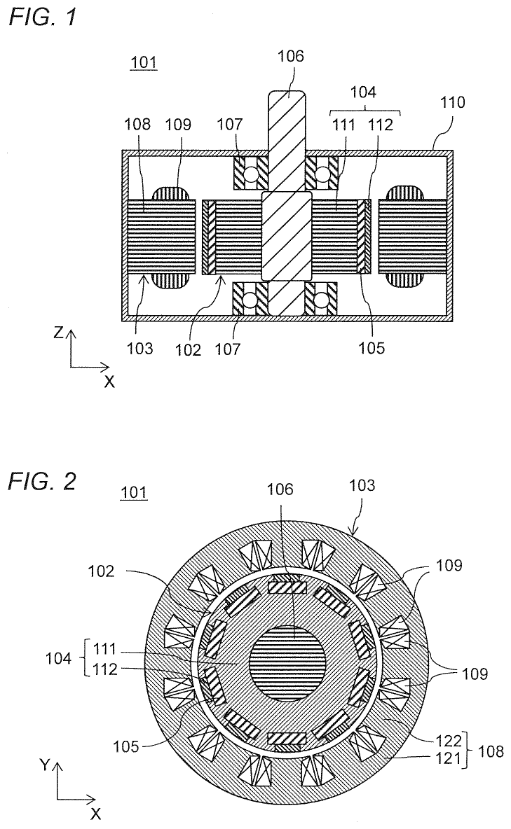

FIG. 1 is a vertical cross-sectional showing a configuration of a motor 101 according to a first embodiment. FIG. 2 is a transverse cross-sectional view showing the configuration of the motor 101 according to the first embodiment. The motor according to the first embodiment is configured as an inner rotor type, in which a rotor is located inside a stator, magnets are provided on the rotor, and windings are provided on the stator.

The motor 101 is provided with a rotor 102, a stator 103, a pair of bearings 107, and a housing 110. The stator 103 and the bearings 107 are fixed to the housing 110. The rotor 102 is rotatably supported by the pair of bearings 107, inside the stator 103.

In FIG. 2 (and other drawings each showing a transverse cross-sectional view of a motor), the housing 110 is omitted for ease of illustration.

In the present specification, a direction in which a rotating shaft 106 extends (Z direction of FIG. 1 and others) is referred to as a direction of the rotating shaft 106 or an axial direction. On a plane orthogonal to the axial direction (XY plane of FIG. 2 and others), directions extending from a center of the rotating shaft 106 are referred to as radial directions, and a direction circling around the center is referred to as a circumferential direction.

The rotor 102 is provided with an inner core 104, a plurality of magnets 105, and the rotating shaft 106. The inner core 104 is a substantially cylindrically-shaped magnetic core. The rotating shaft 106 passes through the inner core 104, and the inner core 104 is mechanically connected to the rotating shaft 106. The rotating shaft 106 is supported by the pair of bearings 107, and the rotor 102 rotates about the rotating shaft 106. The magnets 105 are permanent magnets provided at equal intervals along an outer periphery of the inner core 104. In the example of FIG. 2, ten magnets 105 are provided. For example, each magnet 105 is shaped as a rectangular parallelepiped, a plurality of substantially rectangular holes are formed along the outer periphery of the inner core 104 at equal intervals, and each magnet 105 is inserted into a corresponding hole. Each magnet 105 serves as a magnetic pole of the rotor 102.

In a cross section perpendicular to the rotating shaft 106, the inner core 104 includes a plurality of magnetic material portions made of a plurality of magnetic materials having magnetic characteristics different from each other, respectively, that is, a yoke 111 and high saturation magnetic flux density portions 112. The yoke 111 and the high saturation magnetic flux density portions 112 are adjacent to each other in directions perpendicular to the rotating shaft 106. The yoke 111 is made of a first magnetic material having a first saturation magnetic flux density, and the high saturation magnetic flux density portions 112 are made of a second magnetic material having a second saturation magnetic flux density higher than the first saturation magnetic flux density. In the present specification, the first magnetic material is also referred to as a “low saturation magnetic flux density material”, and the second magnetic material is also referred to as a “high saturation magnetic flux density material”. The yoke 111 contains iron as a main component. For example, the yoke 111 may be non-oriented magnetic steel sheets, whose components contain 97% or more iron and 3% or less silicon. The high saturation magnetic flux density portions 112 contain cobalt at a content rate higher than a cobalt content rate of the yoke 111. For example, the high saturation magnetic flux density portions 112 may be made of permendur, whose components contain 49% iron, 49% cobalt, and 2% vanadium. The high saturation magnetic flux density portions 112 are provided at positions of a high magnetic flux density in the inner core 104. In the example of FIG. 2, the high saturation magnetic flux density portions 112 are provided such that the magnets 105 are opposed to an outer core 108 via the high saturation magnetic flux density portions 112. In the example of FIG. 2, ten high saturation magnetic flux density portions 112 corresponding to the ten magnets 105 are provided. The yoke 111 is configured to support the magnets 105 and the high saturation magnetic flux density portions 112.

The rotor 102 is configured as a magnet-embedded type, in which the magnets 105 are embedded within the inner core 104 such that the magnets 105 are not exposed to a surface of the inner core 104.

The stator 103 is provided with the outer core 108 and a plurality of windings 109. As shown in FIG. 2, the outer core 108 is provided with an annular yoke 121, and a plurality of protrusions 122 (or teeth) protruding from the yoke 121 toward the inner core 104 and extending in the radial direction. The protrusions 122 are arranged along an inner periphery of the yoke 121 at equal intervals, so as to be opposed to the inner core 104 at tips of the protrusions 122. In the example of FIG. 2, twelve protrusions 122 are provided. Each of the windings 109 is wound around the protrusion 122 of the outer core 108k, a plurality of times, via an insulating bobbin (not shown). Each winding 109 may be a round wire, a rectangular wire, or the like.

The outer core 108 contains iron as a main component. For example, the outer core 108 may be non-oriented magnetic steel sheets, whose components contain 97% or more iron and 3% or less silicon.

The inner core 104 and the outer core 108 are formed to be relatively rotatable with respect to each other about the common rotating shaft 106. The inner core 104 is arranged inside the outer core 108 such that the tips of the protrusions 122 of the outer core 108 are opposed to an outer peripheral surface of the rotor 102 via a gap.

The motor 101 is configured by arranging the rotor 102 and the stator 103 configured as described above, inside the housing 110, as shown in FIG. 1. The rotating shaft 106 extends in the axial direction from the inner core 104, and one end of the rotating shaft 106 protrudes outside of the housing 110 as an output shaft for rotationally driving a load.

The motor 101 may be a brushless motor driven by a three-phase alternating current including U phase, V phase, and W phase different from each other by 120 degrees. One of U-phase, V-phase, and W-phase currents is applied to each of the windings 109.

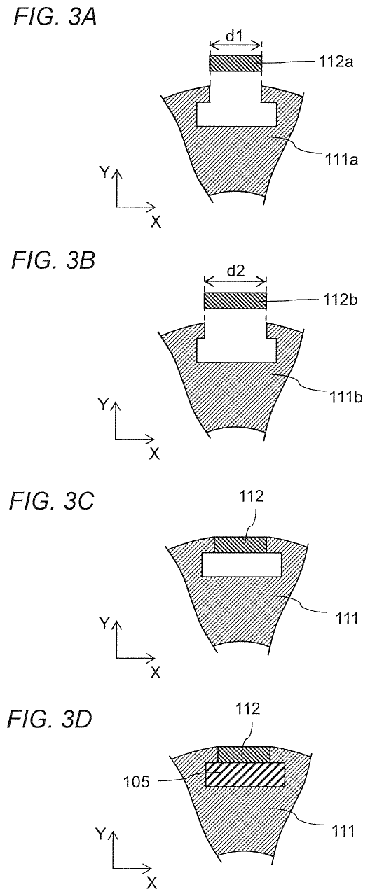

FIGS. 3A to 3D are views showing first to fourth steps of manufacturing the rotor 102 of FIG. 2, respectively. Each of the inner core 104 and the outer core 108 may include a plurality of magnetic sheets stacked in the direction of the rotating shaft 106. Accordingly, each of the yoke 111 and the high saturation magnetic flux density portions 112 of the inner core 104 may also include a plurality of magnetic sheets stacked in the direction of the rotating shaft 106.

FIG. 3A shows one layer of magnetic sheets 111a and 112a, among the plurality of magnetic sheets configuring the yoke 111 and the high saturation magnetic flux density portions 112, respectively. FIG. 3B shows another layer of magnetic sheets 111b and 112b, among the plurality of magnetic sheets configuring the yoke 111 and the high saturation magnetic flux density portions 112, respectively. For example, the magnetic sheets 111a and 111b may be non-oriented electrical steel sheets, and the magnetic sheets 112a and 112b may be permendur. The magnetic sheets 111a and 112a are formed with complementary contours. The magnetic sheets 111b and 112b are formed with complementary contours. The magnetic sheets 111a and 111b have contours different from each other, and the magnetic sheets 112a and 112b also have contours different from each other. In the example of FIGS. 3A and 3B, the magnetic sheet 112a has a contour with a length d1 in X direction, the magnetic sheet 112b has a contour with a length d2 in X direction, and the magnetic sheets 111a and 111b have contours complementary to the magnetic sheets 112a and 112b, respectively. In addition, each of the magnetic sheets 111a and 111b has a substantially rectangular hole into which the magnet 105 is inserted.

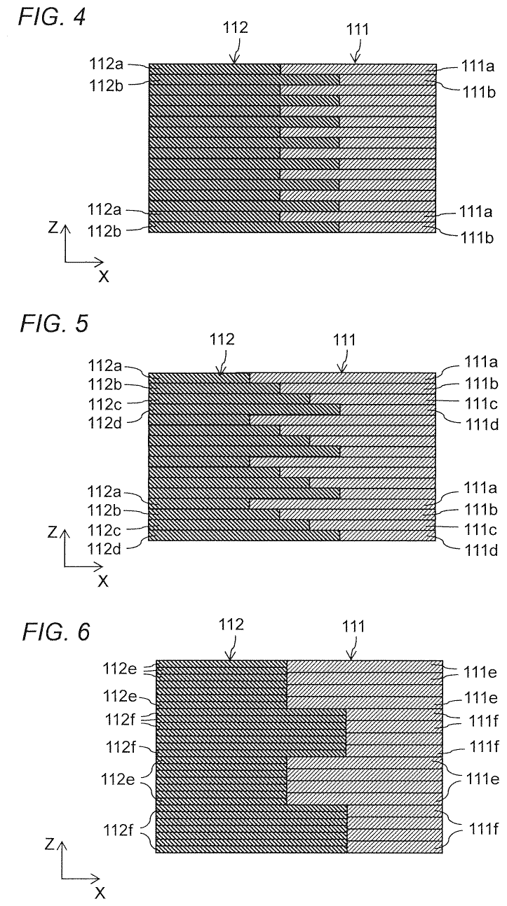

The yoke 111 is configured by alternately stacking the magnetic sheets 111a and 111b. The high saturation magnetic flux density portion 112 is configured by alternately stacking the magnetic sheets 112a and 112b. Thereafter, by inserting the high saturation magnetic flux density portion 112 into the yoke 111 along the radial direction, the yoke 111 and the high saturation magnetic flux density portion 112 are fitted to each other as shown in FIG. 3C. The fitting of the yoke 111 and the high saturation magnetic flux density portion 112 will be described later with reference to FIGS. 4 to 6. The yoke 111 and the high saturation magnetic flux density portion 112 may be fixed to each other using an adhesive or the like. Next, the magnet 105 is inserted into the hole of the yoke 111 as shown in FIG. 3D.

FIG. 4 is a view showing a first jointing method of the yoke 111 and the high saturation magnetic flux density portion 112 of FIG. 2. FIG. 4 shows a portion near a joint between the yoke 111 and the high saturation magnetic flux density portion 112 described with reference to FIGS. 3A to 3D. If the thicknesses of the magnetic sheets 112a and 112b are equal to the thicknesses of the magnetic sheets 111a and 111b, respectively, then the yoke 111 configured by alternately stacking the magnetic sheets 111a and 111b, and the high saturation magnetic flux density portion 112 configured by alternately stacking the magnetic sheets 112a and 112b can be fitted to each other. The magnetic sheets 111a and 112a, and the magnetic sheets 111b and 112b are formed with contours varying periodically and complementarily in the direction of the rotating shaft 106. In the example of FIG. 4, the magnetic sheets 111a and 111b alternate projections and recesses per each layer of the magnetic sheets, and the magnetic sheets 112a and 112b alternate projections and recesses per each layer of the magnetic sheets, complementary to the recesses and projections of the magnetic sheets 111a and 111b. Accordingly, the shape of a side surface of the yoke 111 varies periodically in the direction of the rotating shaft 106, and the shape of a side surface of the high saturation magnetic flux density portion 112 varies complementarily to the side surface of the yoke 111, and periodically in the direction of the rotating shaft 106. The yoke 111 and the high saturation magnetic flux density portion 112 are fitted to each other by aligning the yoke 111 and the high saturation magnetic flux density portion 112 based on their complementary side shapes, and inserting the high saturation magnetic flux density portion 112 into the yoke 111. In the present specification, the fitting as shown in FIG. 4 is also referred to as “butt lap joint”. According to the jointing method of FIG. 4, it is possible to connect different materials with a small gap, avoid reducing inductance, and reduce iron loss.

FIG. 5 is a view showing a second jointing method of the yoke 111 and the high saturation magnetic flux density portion 112 of FIG. 2. FIG. 5 shows a portion near a joint between the yoke 111 and the high saturation magnetic flux density portion 112. The yoke 111 may be configured by repeatedly stacking magnetic sheets 111a to 111d with contours different from each other. The high saturation magnetic flux density portion 112 may also be configured by repeatedly stacking magnetic sheets 112a to 112d with contours different from each other. The magnetic sheets 111a to 111d and the magnetic sheets 112a to 112d are formed with complementary contours, respectively. If the thicknesses of the magnetic sheets 112a to 112d are equal to the thicknesses of the magnetic sheets 111a to 111d, respectively, then the yoke 111 configured by repeatedly stacking the magnetic sheets 111a to 111d, and the high saturation magnetic flux density portion 112 configured by repeatedly stacking the magnetic sheets 112a to 112d can be fitted to each other. The magnetic sheets 111a to 111d and the magnetic sheets 112a to 112d are formed with contours varying periodically and complementarily in the direction of the rotating shaft 106. In the example of FIG. 5, the magnetic sheets 111a to 111d repeat stepped deformation per every four layers of the magnetic sheets, and the magnetic sheets 112a to 112d repeat stepped deformation per every four layers of the magnetic sheets, complementary to the deformation of the magnetic sheets 111a to 111d. Accordingly, the shape of the side surface of the yoke 111 varies periodically in the direction of the rotating shaft 106, and the shape of the side surface of the high saturation magnetic flux density portion 112 varies complementarily to the side surface of the yoke 111, and periodically in the direction of the rotating shaft 106. The yoke 111 and the high saturation magnetic flux density portion 112 are fitted to each other by aligning the yoke 111 and the high saturation magnetic flux density portion 112 based on their complementary side shapes, and inserting the high saturation magnetic flux density portion 112 into the yoke 111. In the present specification, the fitting as shown in FIG. 5 is also referred to as “step lap joint”. According to the jointing method of FIG. 5, it is possible to connect different materials with a small gap, avoid reducing inductance, and reduce iron loss.

The magnetic sheets configuring each of the yoke 111 and the high saturation magnetic flux density portion 112 may repeat stepped deformation or deformation in other shapes per every three or every five or more layers of the magnetic sheets.

FIG. 6 is a view showing a third jointing method of the yoke 111 and the high saturation magnetic flux density portion 112 of FIG. 2. FIG. 6 shows a portion near a joint between the yoke 111 and the high saturation magnetic flux density portion 112. The yoke 111 may be configured by stacking magnetic sheets 111e and 111f with contours different from each other. The high saturation magnetic flux density portion 112 may also be configured by stacking magnetic sheets 112e and 112f with contours different from each other. The magnetic sheets 111e and 112e are formed with complementary contours. The magnetic sheets 111f and 112f are formed with complementary contours. In the example of FIG. 6, the thickness of the magnetic sheets 112e and 112f is different from the thickness of the magnetic sheets 111e and 111f. In this case, the yoke 111 and the high saturation magnetic flux density portion 112 are connected as follows. The magnetic sheets 111e and 111f have a first thickness, for example, 0.35 mm. The magnetic sheets 112e and 112f have a second thickness, for example, 0.2 mm. The magnetic sheets configuring the yoke 111 and the high saturation magnetic flux density portion 112 are formed with contours varying periodically and complementarily per a least common multiple of the first and second thicknesses. The least common multiple of 0.35 mm and 0.2 mm is 1.4 mm. In this case, the yoke 111 is configured by alternately stacking a group of four magnetic sheets 111e and a group of four magnetic sheets 111f. Similarly, the high saturation magnetic flux density portion 112 is configured by alternately stacking a group of seven magnetic sheets 112e and a group of seven magnetic sheets 112f. Accordingly, the shape of the side surface of the yoke 111 varies periodically in the direction of the rotating shaft 106, and the shape of the side surface of the high saturation magnetic flux density portion 112 varies complementarily to the side surface of the yoke 111, and periodically in the direction of the rotating shaft 106. The yoke 111 and the high saturation magnetic flux density portion 112 are fitted to each other by aligning the yoke 111 and the high saturation magnetic flux density portion 112 based on their complementary side shapes, and inserting the high saturation magnetic flux density portion 112 into the yoke 111. The yoke 111 and the high saturation magnetic flux density portion 112 configured by alternately stacking the groups of the magnetic sheets may be fitted to each other using the butt lap joint of FIG. 4, or using the step lap joint of FIG. 5. According to the configuration of FIG. 6, even when the thickness of the magnetic sheets configuring the high saturation magnetic flux density portion 112 is different from the thickness of the magnetic sheets configuring the yoke 111, it is possible to connect different materials with a small gap, avoid reducing inductance, and reduce iron loss.

The magnetic sheets configuring the yoke 111 and the high saturation magnetic flux density portion 112 may be formed with contours varying periodically and complementarily per every integer multiple of the least common multiple of the first and second thicknesses. In the above-described example, the yoke 111 may be configured by alternately stacking a group of “4×n” (n is an integer) magnetic sheets 111e and a group of “4×n” magnetic sheets 111f, and the high saturation magnetic flux density portion 112 may be configured by alternately stacking a group of “7×n” magnetic sheets 112e and a group of “7×n” magnetic sheets 112f.

The outer core 108 may include a plurality of non-oriented electrical steel sheets stacked in the direction of the rotating shaft 106.

According to the first embodiment, the inner core 104 has the high saturation magnetic flux density portions 112 with a high cobalt content rate, at positions of a high magnetic flux density, and has the yoke 111 containing iron as a main component and having good mechanical characteristics, at the other positions. As a result, it is possible to increase the magnetic flux density generated by the magnets 105, and achieve a high torque, while reducing usage of expensive materials including rare metals as much as possible. In addition, it is possible to generate the same torque as the prior art with a smaller current than the prior art. Further, in a case of generating the same torque as the prior art with the same current as the prior art, it is possible to reduce the thicknesses of the inner core 104 and the outer core 108 in the axial direction as compared with the prior art, and reduce the size of the motor 101 as compared with the prior art.

According to the first embodiment, it is possible to achieve a higher torque density than the prior art, that is, a torque as high as possible in the same size, and as a result, it is possible to reduce the size of the motor 101 as compared with the prior art.

According to the first embodiment, it is possible to achieve high efficiency and torque, which were achievable only by typical non-oriented electrical steel sheets used for motors.

In the above example, the case has been described where the high saturation magnetic flux density portion 112 is made of permendur. Permendur has a higher saturation magnetic flux density and a lower iron loss than those of a non-oriented magnetic steel sheet, and it is an expensive material containing a rare metal, i.e., cobalt, as much as iron. If the entire inner core 104 is made of permendur, the cost becomes very high. On the other hand, as shown in FIG. 2 and others, by using permendur only in the high saturation magnetic flux density portions 112 of the inner core 104, it is possible to advantageously improve torque and efficiency, while avoiding an increase in material cost.

According to the first embodiment, it is possible to provide the motor 101 having a higher efficiency and a higher torque density than the prior art, while reducing usage of expensive materials including rare metals as much as possible.

### First Modified Embodiment of First Embodiment

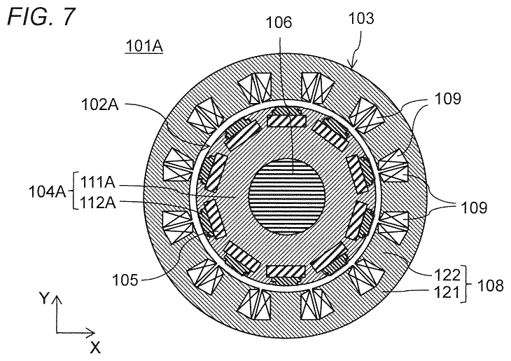

FIG. 7 is a transverse cross-sectional view showing a configuration of a motor 101A according to a first modified embodiment of the first embodiment. The motor 101A is provided with a rotor 102A and a stator 103.

The rotor 102A is provided with an inner core 104A, a plurality of magnets 105, and a rotating shaft 106. In a cross section perpendicular to the rotating shaft 106, the inner core 104A includes a plurality of magnetic material portions made of a plurality of magnetic materials having magnetic characteristics different from each other, respectively, that is, a yoke 111A and high saturation magnetic flux density portions 112A. The inner core 104A is configured in a manner similar to that of the inner core 104 of FIG. 2, except that a joining method of the yoke 111A and the high saturation magnetic flux density portions 112A is different from the jointing method described with reference to FIGS. 4 to 6.

The yoke 111A and the high saturation magnetic flux density portions 112A are formed such that the high saturation magnetic flux density portions 112A can be inserted into the yoke 111A in the direction of the rotating shaft 106, and so as to prevent separation of the yoke 111A and the high saturation magnetic flux density portions 112A in directions perpendicular to the rotating shaft 106. Side surfaces (surfaces along the direction of the rotating shaft 106) of the yoke 111A and the high saturation magnetic flux density portions 112A are formed parallel to the rotating shaft 106. In addition, slots in the yoke 111A for inserting the high saturation magnetic flux density portions 112A are formed so as to be narrowed as farther away from the rotating shaft 106, as seen from the axial direction, and the high saturation magnetic flux density portions 112A are formed complementarily to the slots. This allows the high saturation magnetic flux density portions 112A to be inserted into the yoke 111A in the direction of the rotating shaft 106, and prevents separation of the yoke 111A and the high saturation magnetic flux density portions 112A in directions perpendicular to the rotating shaft 106.

The stator 103 of FIG. 7 is configured in a manner similar to that of the stator 103 of FIG. 2.

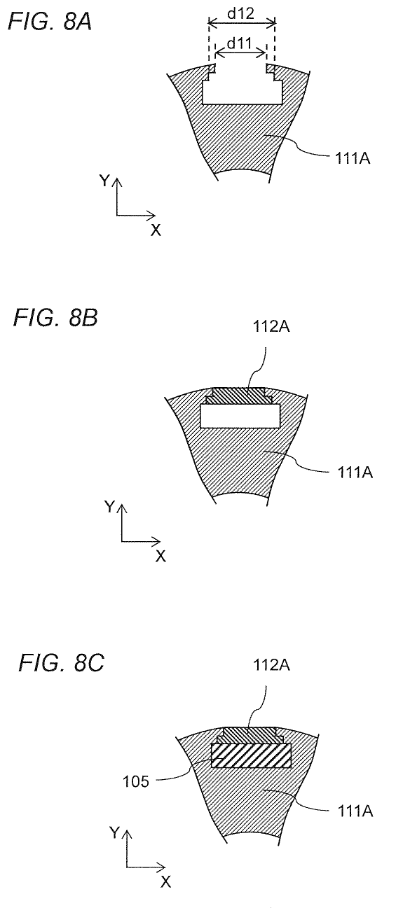

FIGS. 8A to 8C are views showing first to third steps of manufacturing the rotor 102A of FIG. 7, respectively. As shown in FIG. 8A, the yoke 111A is configured by stacking electrical steel sheets having the same contour shape, in the direction of the rotating shaft 106. As described above, the slot in the yoke 111A for inserting the high saturation magnetic flux density portion 112A is formed so as to be narrowed as farther away from the rotating shaft 106, as seen from the axial direction (d11<d12). Next, as shown in FIG. 8B, the high saturation magnetic flux density portion 112A is inserted into the slot of the yoke 111A. The high saturation magnetic flux density portion 112A is formed complementarily to the slot of the yoke 111A as seen from the axial direction. In the example of FIG. 8B, the high saturation magnetic flux density portion 112A may be fitted to the yoke 111A by firstly inserting the high saturation magnetic flux density portion 112A into the slot for the magnet 105, and moving the high saturation magnetic flux density portion 112A from the slot for the magnet 105 in the direction towards the outer periphery. The yoke 111A and the high saturation magnetic flux density portion 112A may be fixed to each other using an adhesive or the like. Next, as shown in FIG. 8C, the magnet 105 is inserted into a hole of the yoke 111A.

According to the configuration of FIG. 7, it is possible to provide the integrated rotor 102A having high mechanical strength, without separating the high saturation magnetic flux density portions 112A from the yoke 111A, even when a centrifugal force due to the rotation of the rotor 102A is applied.

### Second Modified Embodiment of First Embodiment

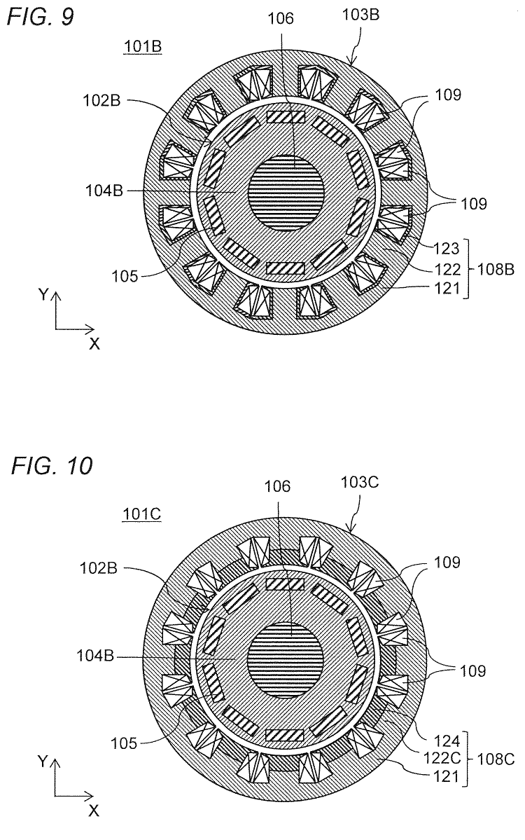

FIG. 9 is a transverse cross-sectional view showing a configuration of a motor 101B according to a second modified embodiment of the first embodiment. The motor 101B is provided with a rotor 102B and a stator 103B.

The rotor 102B is provided with an inner core 104B, a plurality of magnets 105, and a rotating shaft 106. The inner core 104B is made of one magnetic material portion having certain magnetic characteristics. The inner core 104B may include a plurality of non-oriented electrical steel sheets stacked in a direction of the rotating shaft 106. The magnets 105 and the rotating shaft 106 of FIG. 9 are configured in a manner similar to that of the magnets 105 and the rotating shaft 106 of FIG. 2.

The stator 103B is provided with an outer core 108B and a plurality of windings 109. In a cross section perpendicular to the rotating shaft 106, the outer core 108B includes a plurality of magnetic material portions made of a plurality of magnetic materials having magnetic characteristics different from each other, respectively, that is, an annular yoke 121, a plurality of protrusions 122, and a plurality of high saturation magnetic flux density portions 123. The high saturation magnetic flux density portions 123 are adjacent to the yoke 121 and the protrusions 122 at least in directions perpendicular to the rotating shaft 106. The yoke 121 and the protrusions 122 are made of a magnetic material having a first saturation magnetic flux density, and the high saturation magnetic flux density portion 123 is made of another magnetic material having a second saturation magnetic flux density higher than the first saturation magnetic flux density. The yoke 121 and the protrusions 122 contain iron as a main component. For example, the yoke 121 and the protrusions 122 may be non-oriented magnetic steel sheets. The high saturation magnetic flux density portions 123 contain cobalt at a content rate higher than a cobalt content rate of the yoke 121 and the protrusions 122. For example, the high saturation magnetic flux density portions 123 may be made of permendur. The high saturation magnetic flux density portions 123 are provided at positions of a high magnetic flux density in the outer core 108B. In the example of FIG. 9, the high saturation magnetic flux density portions 123 are provided on the surfaces of the protrusions 122 and near the protrusions 122. Each of the windings 109 is wound around the protrusion 122, a plurality of times, via the high saturation magnetic flux density portion 123.

The high saturation magnetic flux density portions 123 may be fitted to the surface of the protrusions 122 and near the protrusions 122, using, for example, one of the jointing methods of FIGS. 4 to 6.

In the example of FIG. 2, the high saturation magnetic flux density portions 112 are used partially in the inner core 104. On the other hand, in the example of FIG. 9, the high saturation magnetic flux density portions 123 are used partially in the outer core 108B. The strength of the magnetic flux passing through the protrusion 122 depends on the number of turns of the winding 109, the current, and the cross-sectional area of the protrusion 122. The magnetic flux circulates by following the protrusion 122, the yoke 121, the adjacent protrusion 122, the magnet 105 and the inner core 104B, and returning to the original protrusion 122. This magnetic flux tends to follow a path of the shortest distance, and thus, the magnetic flux concentrates on portions of the protrusions 122 and the yoke 121, which are close to the windings 109, and the magnetic flux density increases at those portions. Therefore, the high saturation magnetic flux density portions 123 are provided on the surface of the protrusions 122 and near the protrusions 122 (including parts of the yoke 121), that is, the positions of a high magnetic flux density.

According to the configuration of FIG. 9, it is possible to increase the magnetic flux density generated by the magnets 105, and achieve a high torque, while reducing usage of expensive materials including rare metals as much as possible. In addition, it is possible to generate the same torque as the prior art with a smaller current than the prior art. Further, in a case of generating the same torque as the prior art with the same current as the prior art, it is possible to reduce the thicknesses of the inner core 104B and the outer core 108B in the axial direction as compared with the prior art, and reduce the size of the motor 101B as compared with the prior art.

### Third Modified Embodiment of First Embodiment

FIG. 10 is a transverse cross-sectional view showing a configuration of a motor 101C according to a third modified embodiment of the first embodiment. The motor 101C is provided with a rotor 102B and a stator 103C.

The rotor 102B of FIG. 10 is configured in a manner similar to that of the rotor 102B of FIG. 9.

The stator 103C is provided with an outer core 108C and a plurality of windings 109. In a cross section perpendicular to the rotating shaft 106, the outer core 108C includes a plurality of magnetic material portions made of a plurality of magnetic materials having magnetic characteristics different from each other, respectively, that is, an annular yoke 121, a plurality of protrusions 122C, and a plurality of high saturation magnetic flux density portions 124. The high saturation magnetic flux density portions 124 are adjacent to the protrusions 122C at least in directions perpendicular to the rotating shaft 106. The yoke 121 and the protrusions 122C are made of a magnetic material having a first saturation magnetic flux density, and the high saturation magnetic flux density portions 124 are made of another magnetic material having a second saturation magnetic flux density higher than the first saturation magnetic flux density. The yoke 121 and the protrusions 122C contain iron as a main component. For example, the yoke 121 and the protrusions 122C may be non-oriented magnetic steel sheets. The high saturation magnetic flux density portions 124 contain cobalt at a content rate higher than a cobalt content rate of the yoke 121 and the protrusions 122C. For example, the high saturation magnetic flux density portions 124 may be made of permendur. The high saturation magnetic flux density portions 124 are provided at positions of a high magnetic flux density in the outer core 108C. In the example of FIG. 10, the high saturation magnetic flux density portions 124 are provided at the tips of the protrusions 122C.

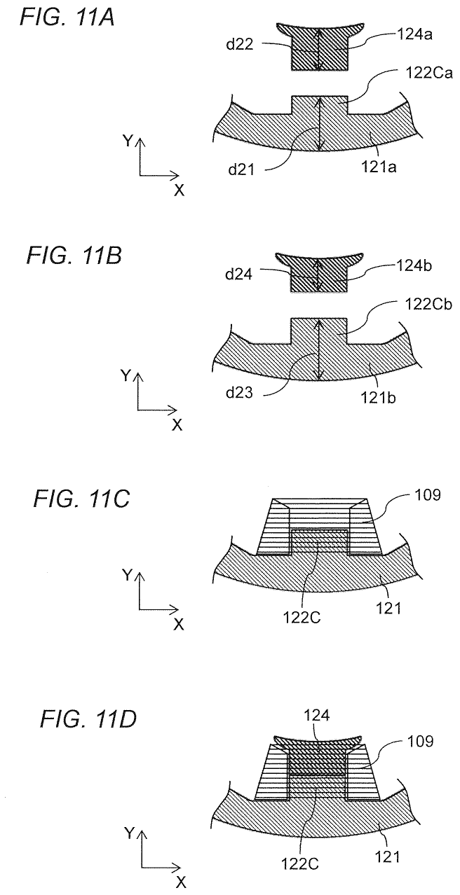

FIGS. 11A to 11D are views showing first to fourth steps of manufacturing the stator 103C of FIG. 10, respectively. The yoke 121, the protrusions 122C, and the high saturation magnetic flux density portions 124 of the outer core 108C may include a plurality of magnetic sheets stacked in a direction of the rotating shaft 106, respectively.

FIG. 11A shows one layer of magnetic sheets 121a and 124a, among the plurality of magnetic sheets configuring the yoke 121, the protrusions 122C, and the high saturation magnetic flux density portions 124, respectively. FIG. 11B shows one layer of magnetic sheets 121b and 124b, among the plurality of magnetic sheets configuring the yoke 121, the protrusions 122C, and the high saturation magnetic flux density portions 124, respectively. The magnetic sheets 121a and 121b have protrusions 122Ca and 122Cb protruding inward and extending in the radial direction, respectively. For example, the magnetic sheets 121a and 121b may be non-oriented electrical steel sheets, and the magnetic sheets 124a and 124b may be made of permendur. The protrusion 122Ca and the magnetic sheet 124a are formed with complementary contours. The protrusion 122Cb and the magnetic sheet 124b are formed with complementary contours. The protrusions 122Ca and 122Cb have contours different from each other, and the magnetic sheets 124a and 124b also have contours different from each other. In the example of FIGS. 11A and 11B, the protrusion 122Ca has a contour with a length d21 in Y direction, the magnetic sheet 124a has a contour with a length d22 in Y direction, the protrusion 122Cb has a contour with a length d23 in Y direction, and the magnetic sheet 124b has a contour with a length d24 in Y direction. The lengths d21 to d24 satisfy: d21≠d23, d22≠d24, and d21+d22=d23+d24.

The yoke 121 and the protrusion 122C are configured by alternately stacking the magnetic sheets 121a and 121b. The high saturation magnetic flux density portion 124 is configured by alternately stacking the magnetic sheets 124a and 124b. Next, as shown in FIG. 11C, the winding 109 is wound around the protrusion 122C. Thereafter by moving the high saturation magnetic flux density portion 124 toward the protrusion 122C along the radial direction, the high saturation magnetic flux density portion 124 fits into the protrusion 122C as shown in FIG. 11D. One of the jointing methods described with reference to FIGS. 4 to 6 can be applied to the fitting of the high saturation magnetic flux density portion 124 into the protrusion 122C. The high saturation magnetic flux density portion 124 may be fixed to the protrusion 122C using an adhesive or the like.

In the steps of FIGS. 11A to 11D, the winding 109 are wound around the linear protrusion 122C. Therefore, for example, even when the tip of the high saturation magnetic flux density portion 124 is wider than the protrusion 122C, the winding 109 made of flat wire or the like, which has been wound in advance, can be incorporated in the stator 103C.

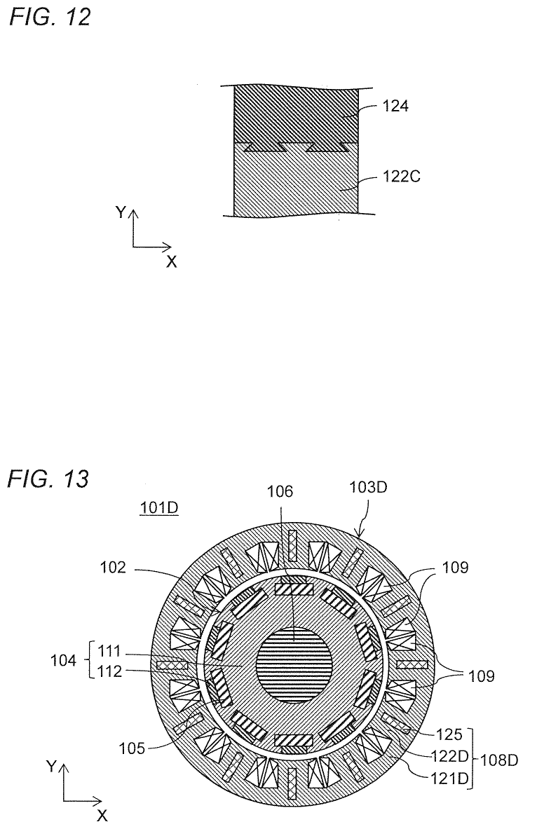

FIG. 12 is a view showing another jointing method of the protrusion 122C and the high saturation magnetic flux density portion 124 of FIG. 10. The protrusion 122C and the high saturation magnetic flux density portion 124 may be formed such that the high saturation magnetic flux density portion 124 can be inserted into the protrusion 122C in the direction of the rotating shaft 106, and so as to prevent separation of the protrusion 122C and the high saturation magnetic flux density portion 124 in directions perpendicular to the rotating shaft. For example, as shown in FIG. 12, the protrusion 122C and the high saturation magnetic flux density portion 124 may be fitted to each other using a dovetail joint.

As described with reference to FIG. 9, the magnetic flux circulates by following the protrusion 122, the yoke 121, the adjacent protrusion 122, the magnet 105 and the inner core 104, and returning to the original protrusion 122. In this case, particularly at the tip of the protrusion 122, its width is reduced, and the cross-sectional area of the magnetic core through which the magnetic flux passes is reduced, and therefore, the magnetic flux density increases, and the iron loss also increases. Therefore, according to the configuration of FIG. 10, the high saturation magnetic flux density portions 124 are provided at the tips of the protrusions 122C around which the windings 109 are wound.

According to the configuration of FIG. 10, it is possible to increase the magnetic flux density generated by the magnets 105, and achieve a high torque, while reducing usage of expensive materials including rare metals as much as possible. In addition, it is possible to generate the same torque as the prior art with a smaller current than the prior art. Further, in a case of generating the same torque as the prior art with the same current as the prior art, it is possible to reduce the thicknesses of the inner core 104B and the outer core 108C in the axial direction as compared with the prior art, and reduce the size of the motor 101C as compared with the prior art.

### Second Embodiment

FIG. 13 is a transverse cross-sectional view showing a configuration of a motor 101D according to a second embodiment. The motor 101D is provided with a rotor 102 and a stator 103D.

The rotor 102 of FIG. 13 is configured in a manner similar to that of the rotor 102 of FIG. 2.

The stator 103D is provided with an outer core 108D and a plurality of windings 109. In a cross section perpendicular to a rotating shaft 106, the outer core 108D includes a plurality of magnetic material portions made of a plurality of magnetic materials having magnetic characteristics different from each other, respectively, that is, a yoke 121D, protrusions 122D, and low iron-loss portions 125. The low iron-loss portions 125 are adjacent to the yoke 121D and the protrusions 122D in directions perpendicular to the rotating shaft 106. The yoke 121D and the protrusions 122D are made of a magnetic material having a first iron loss, and the low iron-loss portions 125 are made of another magnetic material having a second iron loss lower than the first iron loss. The yoke 121D and the protrusions 122D contain iron as a main component. For example, the yoke 111D and the protrusions 122D may be non-oriented magnetic steel sheets, whose components contain 97% or more iron and 3% or less silicon. The low iron-loss portions 125 contain silicon at a content rate higher than a silicon content rate of the yoke 111D and the protrusions 122D. For example, the low iron-loss portions 125 may be magnetic steel sheets, whose components contain 95% iron and 5% silicon. The silicon content rate of the low iron-loss portions 125 may be 6 to 6.5% or the like. The low iron-loss portions 125 are provided at positions of a low magnetic flux density in the outer core 108D. In the example of FIG. 13, the low iron-loss portions 125 are provided inside the protrusions 122D, and surrounded by the yoke 121D and the protrusions 122D.

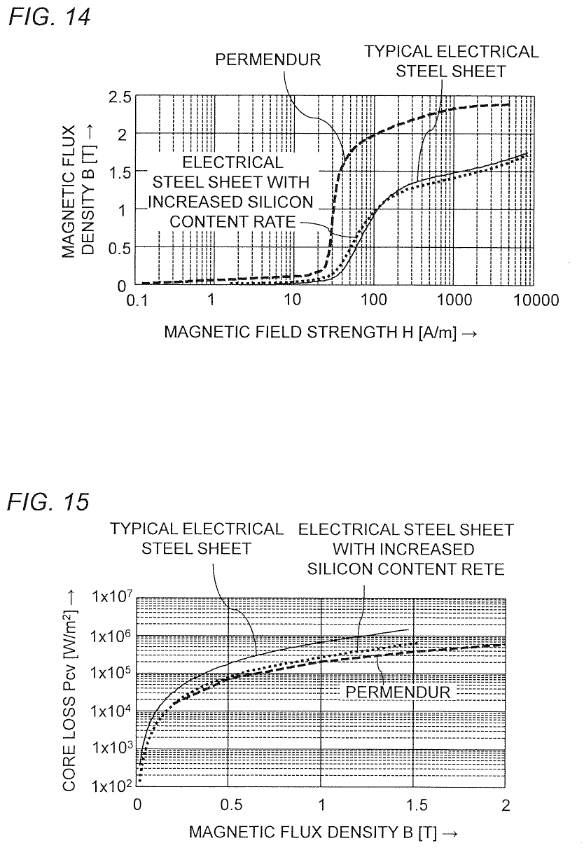

FIG. 14 is a graph showing magnetization characteristics of magnetic materials used in the motor of FIG. 13. FIG. 14 shows magnetization characteristics of a typical electrical steel sheet (non-oriented electrical steel sheet), permendur, and an electrical steel sheet with increased silicon content rate. Permendur has the highest saturation magnetic flux density, the non-oriented electrical steel sheet has the next highest saturation magnetic flux density, and the electrical steel sheet with increased silicon content rate has the lowest saturation magnetic flux density.

FIG. 15 is a graph showing iron loss characteristics of magnetic materials used in the motor of FIG. 13. The permendur has the lowest iron loss, the electrical steel sheet with increased silicon content rate has the next lowest iron loss, and the non-oriented electrical steel sheet has the highest iron loss.

As described above, the magnetic flux circulates by following the protrusion 122D, the yoke 121D, the adjacent protrusion 122D, the magnet 105 and the inner core 104, and returning to the original protrusion 122D. This magnetic flux tends to follow a path of the shortest distance, and thus, the magnetic flux concentrates on portions of the protrusions 122D and the yoke 121D, which are close to the windings 109, and the magnetic flux density increases at these portions. On the other hand, the magnetic flux density at the center within the protrusion 122D is lower than that on the surface of the protrusion 122D. Therefore, by providing the low iron-loss portions 125 having increased silicon content rate, inside the protrusions 122D, it is possible to reduce the iron loss, without magnetic saturation within the protrusions 122D.

In general, adding silicon to a non-oriented electrical steel sheet results in an increased magnetic permeability and an increased specific resistance, thus reducing the iron loss. However, at the same time, embrittlement proceeds, and the mechanical strength degrades. According to the configuration of FIG. 13, it is possible to improve the mechanical reliability by surrounding the low iron-loss portions 125 by the yoke 121D and the protrusions 122D.

### First Modified Embodiment of Second Embodiment

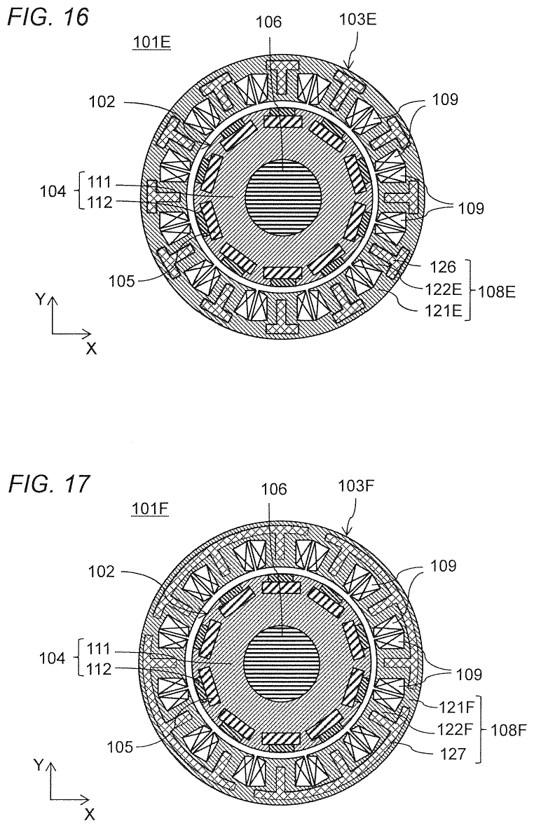

FIG. 16 is a transverse cross-sectional view showing a configuration of a motor 101E according to a first modified embodiment of the second embodiment. The motor 101E is provided with a rotor 102 and a stator 103E.

The rotor 102 of FIG. 16 is configured in a manner similar to that of the rotor 102 of FIG. 2.

The stator 103E is provided with an outer core 108E and a plurality of windings 109. In a cross section perpendicular to a rotating shaft 106, the outer core 108E includes a plurality of magnetic material portions made of a plurality of magnetic materials having magnetic characteristics different from each other, respectively, that is, a yoke 121E, protrusions 122E, and low iron-loss portions 126. The outer core 108E is configured in a manner similar to that of the outer core 108D of FIG. 13, except that the low iron-loss portions 126 are T-shaped.

### Second Modified Embodiment of Second Embodiment

FIG. 17 is a transverse cross-sectional view showing a configuration of a motor 101F according to a second modified embodiment of the second embodiment. The motor 101F is provided with a rotor 102 and a stator 103F.

The rotor 102 of FIG. 17 is configured in a manner similar to that of the rotor 102 of FIG. 2.

The stator 103F is provided with an outer core 108F and a plurality of windings 109. In a cross section perpendicular to a rotating shaft 106, the outer core 108F includes a plurality of magnetic material portions made of a plurality of magnetic materials having magnetic characteristics different from each other, respectively, that is, a yoke 121F, protrusions 122F, and low iron-loss portions 127. Each of the low iron-loss portions 127 has a configuration in which several low iron-loss portions 126 of FIG. 16 are connected to each other.

The low iron-loss portions are not limited to the configurations of FIGS. 13, 16, and 17, and may have any configuration as necessary.

### Third Modified Embodiment of Second Embodiment

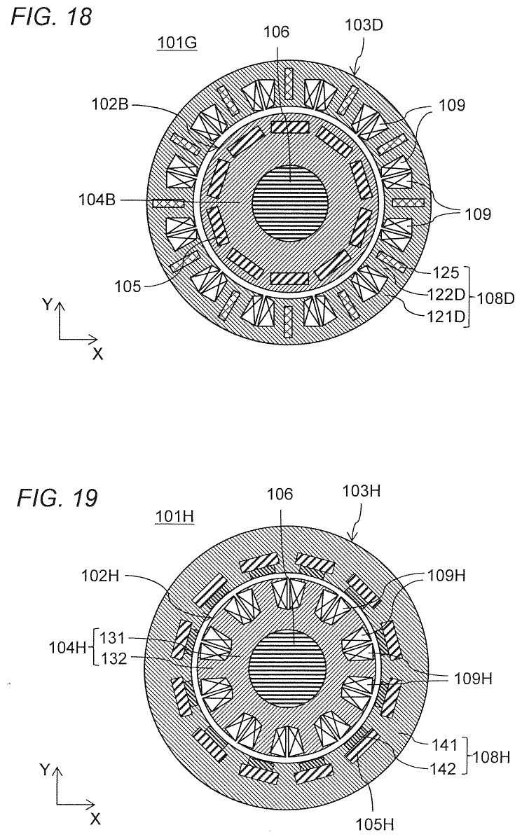

FIG. 18 is a transverse cross-sectional view showing a configuration of a motor 101G according to a third modified embodiment of the second embodiment. The motor 101G is provided with a rotor 102B and a stator 103D. The rotor 102B of FIG. 18 is configured in a manner similar to that of the rotor 102B of FIG. 9. The stator 103D of FIG. 18 is configured in a manner similar to that of the stator 103D of FIG. 13. According to the configuration of FIG. 18, it is possible to reduce the loss and improve the efficiency as compared with those of the combination of the rotor 102B of FIG. 9 and the stator 103 of FIG. 2.

The arrangement of the high saturation magnetic flux density portions and the low iron-loss portions is not limited to those described above. The high saturation magnetic flux density portions may be arranged at any positions of a high magnetic flux density, and the low iron-loss portions may be arranged at any positions of a low magnetic flux density.

### Third Embodiment

FIG. 19 is a transverse cross-sectional view showing a configuration of a motor 101H according to a third embodiment. The motor according to the third embodiment is configured as an inner rotor type, in which a rotor is located inside a stator, windings are provided on the rotor, and magnets are provided on the stator.

The motor 101H is provided with a rotor 102H and a stator 103H.

The rotor 102H is provided with an inner core 104H, a rotating shaft 106, and a plurality of windings 109H. The rotating shaft 106 passes through the inner core 104H, and the inner core 104H is mechanically connected to the rotating shaft 106. The inner core 104H has a yoke 131, and a plurality of protrusions 132 protruding from the yoke 131 toward an outer core 108H (described later) of the stator 103H and extending in the radial direction. The protrusions 132 are arranged along an outer periphery of the yoke 131 at equal intervals, so as to be opposed to the outer core 108H at the tips of the protrusions 132. Each of the windings 109H is wound around the protrusion 132 of the inner core 104H, a plurality of times, via an insulating bobbin (not shown).

The stator 103H includes a plurality of magnets 105H and the outer core 108H. The outer core 108H has a yoke 141 and high saturation magnetic flux density portions 142. The plurality of magnets 105H are permanent magnets provided along an inner periphery of the outer core 108H at equal intervals.

In a cross section perpendicular to the rotating shaft 106, the outer core 108H includes a plurality of magnetic material portions made of a plurality of magnetic materials having magnetic characteristics different from each other, respectively, that is, the yoke 141 and the high saturation magnetic flux density portions 142. The yoke 141 and the high saturation magnetic flux density portions 142 are adjacent to each other in directions perpendicular to the rotating shaft 106. The yoke 141 is made of a magnetic material having a first saturation magnetic flux density, and the high saturation magnetic flux density portions 142 are made of another magnetic material having a second saturation magnetic flux density higher than the first saturation magnetic flux density. The high saturation magnetic flux density portions 142 are provided at positions of a high magnetic flux density in the outer core 108H. In the example of FIG. 19, the high saturation magnetic flux density portions 142 are provided such that the magnets 105H are opposed to the inner core 104H via the high saturation magnetic flux density portions 142. The yoke 141 is configured to support the magnets 105H and the high saturation magnetic flux density portions 142.

The stator 103H is configured as a magnet-embedded type, in which the magnets 105H are embedded within the outer core 108H such that the magnets 105H are not exposed to a surface of the outer core 108H.

The inner core 104H and the outer core 108H are formed to be relatively rotatable with respect to each other about the common rotating shaft 106.

The yoke 141 and the high saturation magnetic flux density portions 142 may be fitted to each other, using one of the jointing methods shown in FIGS. 4 to 6 and 12.

The motor 101H may be driven by alternating current (for example, three-phase alternating current) or by direct current. In the former case, the motor 101H is provided with a brush, and in the latter case, the motor 101H is provided with a commutator and a brush.

According to the third embodiment, it is possible to provide the motor 101H having a higher efficiency and a higher torque density than the prior art, while reducing usage of expensive materials including rare metals as much as possible, similarly to the first and second embodiments.

### Fourth Embodiment

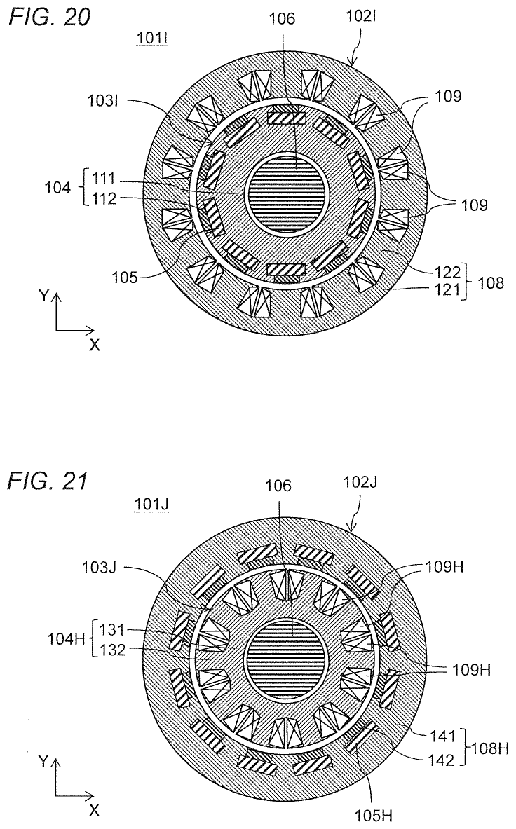

FIG. 20 is a transverse cross-sectional view showing a configuration of a motor 101I according to a fourth embodiment. The motor according to the fourth embodiment is configured as an outer rotor type, in which a rotor is located outside a stator, windings are provided on the rotor, and magnets are provided on the stator.

The motor 101I is provided with a rotor 102I and a stator 103I. A rotating shaft 106 is mechanically connected to an outer core 108, instead of an inner core 104. In other aspects, components of the motor 101I are configured substantially similarly to the respective components of the motor 101 of FIG. 2.

The motor 101I may be driven by alternating current (for example, three-phase alternating current) or by direct current. In the former case, the motor 101I is provided with a brush, and in the latter case, the motor 101I is provided with a commutator and a brush.

According to the fourth embodiment, it is possible to provide the motor 101I having a higher efficiency and a higher torque density than the prior art, while reducing usage of expensive materials including rare metals as much as possible.

### Fifth Embodiment

FIG. 21 is a transverse cross-sectional view showing a configuration of a motor 101J according to a fifth embodiment. The motor according to the fifth embodiment is configured as an outer rotor type, in which a rotor is located outside a stator, magnets are provided on the rotor, and windings are provided on the stator.

The motor 101J is provided with a rotor 102J and a stator 103J. A rotating shaft 106 is mechanically connected to an outer core 108H, instead of an inner core 104H. In other aspects, components of the motor 101J are configured substantially similarly to the components of the motor 101H of FIG. 19.

The motor 101J is driven by alternating current (for example, three-phase alternating current).

According to the fifth embodiment, it is possible to provide the motor 101J having a higher efficiency and a higher torque density than the prior art, while reducing usage of expensive materials including rare metals as much as possible.

### Sixth Embodiment

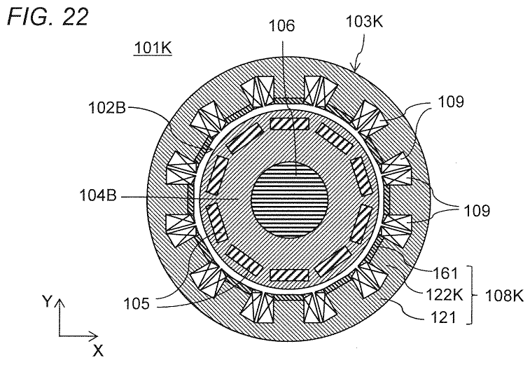

FIG. 22 is a transverse cross-sectional view showing a configuration of a motor 101K according to the sixth embodiment. The motor according to the present embodiment is configured as an inner rotor type, in which a rotor is located inside a stator, magnets are provided on the rotor, and windings are provided on the stator.

The motor 101K is provided with a rotor 102B and a stator 103K. The stator 103K and bearings 107 are fixed to a housing 110.

The rotor 102B of FIG. 22 is configured in a manner similar to that of the rotor 102B of FIG. 9.

The stator 103K is provided with an outer core 108K and a plurality of windings 109. The outer core 108K has a yoke 121 and a plurality of protrusions 122K.

In a cross section perpendicular to a rotating shaft 106, the outer core 108K includes a plurality of magnetic material portions made of a plurality of magnetic materials having magnetic characteristics different from each other, respectively. Most of the outer core 108K is made of a first magnetic material (low saturation magnetic flux density material) having a first saturation magnetic flux density, and some of the outer core 108K is made of a second magnetic material (high saturation magnetic flux density material) having a second saturation magnetic flux density higher than the first saturation magnetic flux density. The low saturation magnetic flux density material contains iron as a main component. For example, the low saturation magnetic flux density material may be non-oriented magnetic steel sheets. The high saturation magnetic flux density material contains cobalt at a content rate higher than a cobalt content rate of the low saturation magnetic flux density material. For example, the high saturation magnetic flux density material may be made of permendur. In the example of FIG. 22,
a reference sign 161 denotes portions made of the high saturation magnetic flux density material. The portions 161 made of the high saturation magnetic flux density material are provided at positions of a high magnetic flux density in the outer core 108K. In the example of FIG. 22, the portions 161 made of the high saturation magnetic flux density material are provided at the tips of the protrusions 122K.

The outer core 108K may be formed using a 3D printing technique as described later.

FIG. 23 is a view showing a detailed configuration of the protrusion 122K of FIG. 22. Each protrusion 122K has a protrusion base 151 and a protrusion end 152, the protrusion base 151 being connected to the yoke 121 and extending in the radial direction with respect to the rotating shaft 106, and the protrusion end 152 being connected to a distal end of the protrusion base 151 and extending in the circumferential direction with respect to the rotating shaft 106. Here, the “radial direction” indicates Y direction in the protrusion 122K of FIG. 23, and the “circumferential direction” roughly indicates X direction in the portion of the yoke 121 of FIG. 23. The length of the protrusion end 152 in the circumferential direction is longer than the length of the protrusion base 151 in the circumferential direction. The protrusion end 152 includes a portion connected to the protrusion base 151 and made of the high saturation magnetic flux density material. In the example of FIG. 23, the protrusion end 152 includes the portion 161 made of the high saturation magnetic flux density material, and portions 162 made of the low saturation magnetic flux density material. The protrusion base 151 and the yoke 121 are all made of the low saturation magnetic flux density material.

The strength of the magnetic flux passing through the protrusion 122K depends on the number of turns of the winding 109, the current, and the cross-sectional area of the protrusion 122K. The magnetic flux circulates by following the protrusion 122K, the yoke 121, the adjacent protrusion 122K, the magnet 105 and the inner core 104B, and returning to the original protrusion 122K. In this case, particularly at the tip of the protrusion 122K, the magnetic flux density increases, and the iron loss also increases. According to the sixth embodiment, the outer core 108K is made of the high saturation magnetic flux density material having a high cobalt content rate, at positions of a high magnetic flux density, and made of the low saturation magnetic flux density material containing iron as a main component and having good mechanical characteristics, at other positions. As a result, it is possible to increase the magnetic flux density generated by the magnets 105, and achieve a high torque, while reducing usage of expensive materials including rare metals as much as possible. In addition, it is possible to generate the same torque as the prior art with a smaller current than the prior art. Further, in a case of generating the same torque as the prior art with the same current as the prior art, it is possible to reduce the thicknesses of the inner core 104B and the outer core 108K in the axial direction as compared with the prior art, and reduce the size of the motor 101K as compared with the prior art.

According to the sixth embodiment, it is possible to achieve a higher torque density than the prior art, that is, a torque as high as possible in the same size, and as a result, it is possible to reduce the size of the motor 101K as compared with the prior art.

According to the sixth embodiment, it is possible to achieve high efficiency and torque, which were achievable only by typical non-oriented electrical steel sheets used for motors.

As shown in FIGS. 22 and 23, by using the high saturation magnetic flux density material, such as permendur, in only a part of each protrusion 122K of the outer core 108K, it is possible to advantageously improve torque and efficiency, while avoiding an increase in material cost.

According to the sixth embodiment, it is possible to provide the motor 101K having a higher efficiency and a higher torque density than the prior art, while reducing usage of expensive materials including rare metals as much as possible.

Next, modified embodiments of the sixth embodiment will be described.

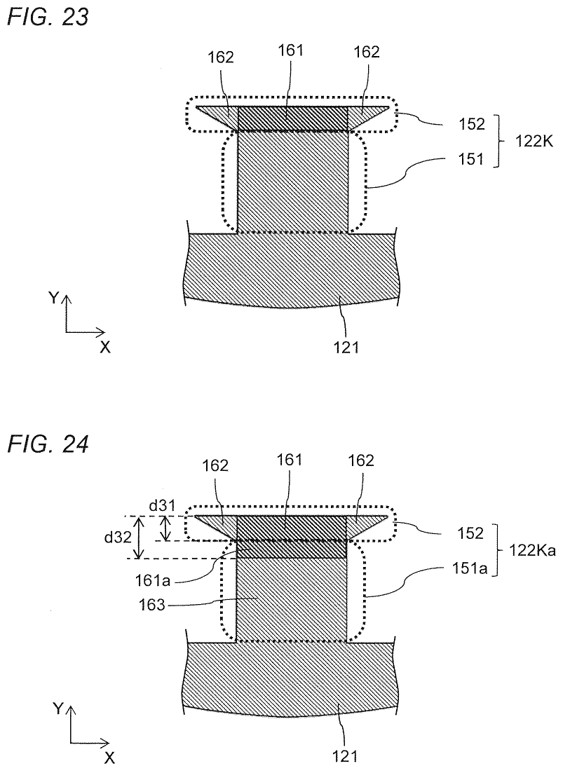

FIG. 24 is a view showing a detailed configuration of a protrusion 122Ka according to a first modified embodiment of the sixth embodiment. The protrusion 122Ka has a protrusion base 151a and a protrusion end 152. The protrusion base 151a includes a portion 161a connected to the protrusion end 152 and made of a high saturation magnetic flux density material, and a portion 163 connected to a yoke 121 and made of a low saturation magnetic flux density material. In practice, the portion 161a of the protrusion base 151a, which is made of the high saturation magnetic flux density material, and a portion 161 of the protrusion end 152, which is made of the high saturation magnetic flux density material, are integrally formed. Here, the total length d32 of the portions 161 and 161a made of the high saturation magnetic flux density material in the radial direction is longer than the length d31 of the protrusion end 152 in the radial direction. According to the configuration of FIG. 24, it is possible to improve torque and efficiency by increasing the portion made of the high saturation magnetic flux density material as compared with the case of FIG. 23.

FIG. 25 is a view showing a detailed configuration of a protrusion 122Kb according to a second modified embodiment of the sixth embodiment. The protrusion 122Kb has a protrusion base 151 and a protrusion end 152b. The protrusion end 152b includes a portion 161b made of a high saturation magnetic flux density material, and portions 162b made of a low saturation magnetic flux density material. Here, the length d42 of the portion 161b made of the high saturation magnetic flux density material in the circumferential direction is longer than the length d41 of the protrusion base 151 in the circumferential direction. According to the configuration of FIG. 25, it is possible to improve torque and efficiency by increasing the portion made of the high saturation magnetic flux density material as compared with the case of FIG. 23.

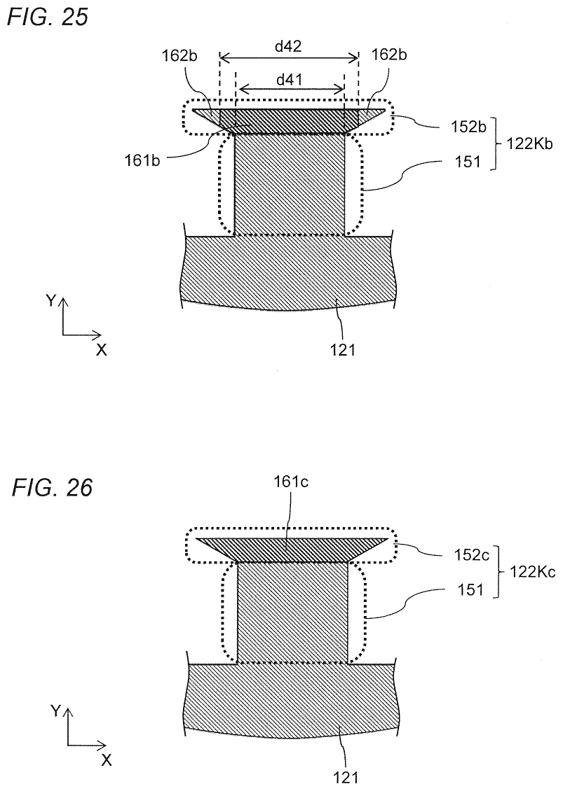

FIG. 26 is a view showing a detailed configuration of a protrusion 122Kc according to a third modified embodiment of the sixth embodiment. The protrusion 122Kc has a protrusion base 151 and a protrusion end 152c. In the example of FIG. 26, the protrusion end 152c is fully configured by a portion 161c made of a high saturation magnetic flux density material. According to the configuration of FIG. 26, it is possible to further improve torque and efficiency by increasing the portion made of the high saturation magnetic flux density material as compared with the case of FIG. 25.

The configurations of FIGS. 24 to 26 may be combined with each other. That is, the portion made of the high saturation magnetic flux density material may be expanded both in the radial direction and in the circumferential direction.

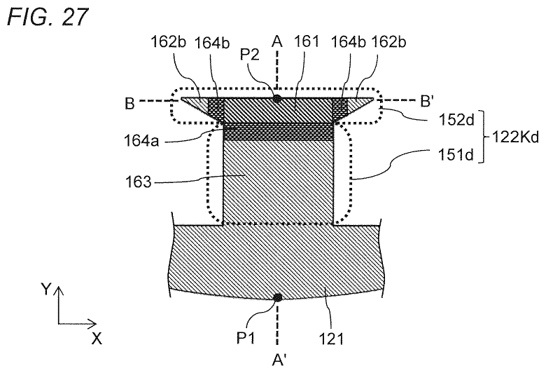

FIG. 27 is a view showing a detailed configuration of a protrusion 122Kd according to a fourth modified embodiment of the sixth embodiment. The protrusion 122Kd has a protrusion base 151d and a protrusion end 152d. The protrusion base 151d includes a portion 163 made of a low saturation magnetic flux density material, and a transition region 164a, and the protrusion end 152d includes a portion 161 made of a high saturation magnetic flux density material, portions 162 made of a low saturation magnetic flux density material, and transition regions 164b.

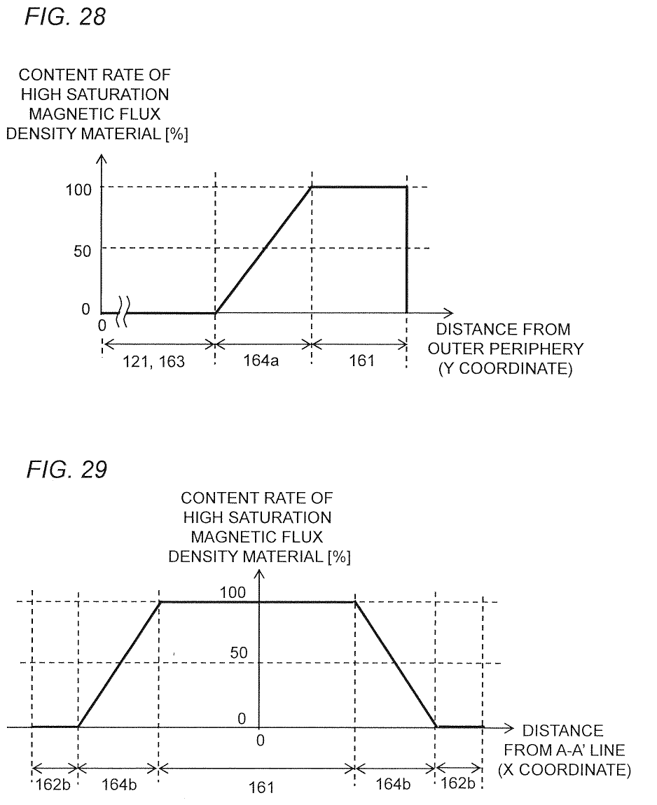

FIG. 28 is a graph showing a change in content rate of high saturation magnetic flux density material with respect to positions along line A-A′ of FIG. 27. The horizontal axis of FIG. 28 indicates positions along line A-A′ of FIG. 27, that is, a distance from point P1 on an outer periphery of a yoke 121. The portion 161 includes only the high saturation magnetic flux density material. The yoke 121 and the portion 163 do not include the high saturation magnetic flux density material, but include only the low saturation magnetic flux density material. In the transition region 164a of the protrusion base 151d, the content rate of the high saturation magnetic flux density material gradually decreases, and the content rate of the low saturation magnetic flux density material gradually increases, as approaching the yoke 121, that is, as the distance from the protrusion end 152d increases.

FIG. 29 is a graph showing a change in content rate of high saturation magnetic flux density material with respect to positions along line B-B′ of FIG. 27. The horizontal axis of FIG. 29 indicates positions along line B-B′ of FIG. 27, that is, a distance from the center of the protrusion base 151d (that is, point P2 on line A-A′). The portion 161 includes only the high saturation magnetic flux density material. The portions 162b do not include the high saturation magnetic flux density material, but include only the low saturation magnetic flux density material. In the transition regions 164b of the protrusion end 152d, the content rate of the high saturation magnetic flux density material gradually decreases, and the content rate of the low saturation magnetic flux density material gradually increases, as the distance from the center of the protrusion base 151d increases.

In order to gradually change the content rate of the high saturation magnetic flux density material in the transition regions 164a and 164b, for example, the content rate of cobalt may be gradually changed.

According to the configuration of FIG. 27, by gradually changing the content rate of the high saturation magnetic flux density material, it is possible to avoid cracks at the boundary between the high saturation magnetic flux density material and the low saturation magnetic flux density material.

The protrusion may include only one of the transition regions 164a and 164b of FIG. 27.

The motor according to the sixth embodiment has been configured as the inner rotor type, in which the rotor is located inside the stator, magnets are provided on the rotor, and windings are provided on the stator. However, the described principle can also be applied to a motor of an outer rotor type, in which a rotor is located outside a stator, and applied to a motor in which windings are provided on a rotor, and magnets are provided on a stator.

### Seventh Embodiment

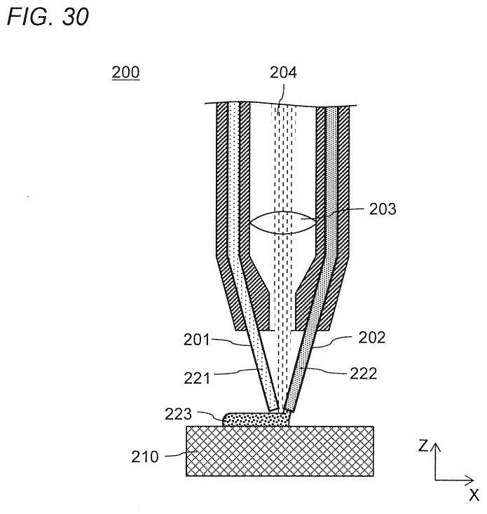

FIG. 30 is a view showing a configuration of a part of a motor manufacturing apparatus according to a seventh embodiment.

While the above-described embodiments mainly indicate the examples using the electrical steel sheets, the inner core and the outer core may be configured using a method of constructing magnetic material portions using a so-called 3D printing technique, as referred to additive manufacturing (AM). There are several methods of forming a structure using metal powder. As an example, the inner core and the outer core may be formed according to a method using a direct energy deposition (DED), the method including: using a laser beam, an electron beam, or a plasma arc as a heat source, injecting and converging metal powder from a nozzle, and melting and injecting metal.

FIG. 30 shows an apparatus 200 for 3D printing using the direct energy deposition.

For example, the rotor 102 of FIG. 2 may be configured using the apparatus 200 as follows. When forming the yoke 111 of FIG. 2, the apparatus 200 supplies metal powder 221 from a first nozzle 201 onto a substrate 210, the metal powder 221 containing iron as a main component; melts the metal powder 221 by a laser beam 204 focused by a lens 203, or the like, to form a metal product 223; and repeats melting and forming the metal, while moving in the radial direction (for example, X direction). When forming the high saturation magnetic flux density portion 112, the apparatus 200 switches to a second nozzle 202; supplies metal powder 222 onto the substrate 210, the metal powder 222 containing iron and cobalt as main components; melts the metal powder 222 by the laser beam 204 or the like to form a metal product 223; and repeats melting and forming the metal, while moving in the radial direction. A hole is provided at a position where the magnet 105 is inserted. Thus, one layer of the inner core 104 is formed. Next, the apparatus 200 moves in Z direction, and similarly repeats supplying, melting, and forming the metal powder with the same configuration on the one layer, and repeats these steps to stack in a desired axial direction, thus forming the inner core 104. Finally, the magnet 105 is inserted into the hole of the inner core 104, and thus, the rotor 102 is configured.

In addition, the stator 103K of FIG. 22 may be configured using the apparatus 200 as follows. When forming the yoke 121, the protrusion base 151, and the portions 162 made of the low saturation magnetic flux density material of FIG. 23, the apparatus 200 supplies the metal powder 221 from the first nozzle 201 onto the substrate 210, the metal powder 221 containing iron as a main component; melts the metal powder 221 by the laser beam 204 focused by the lens 203 or the like to form a metal product 223; and repeats melting and forming the metal, while moving in the radial direction (for example, X direction). When forming the portion 161 made of the high saturation magnetic flux density material, the apparatus 200 switches to the second nozzle 202; supplies the metal powder 222 onto the substrate 210, the metal powder 222 containing iron and cobalt as main components; melts the metal powder 222 by the laser beam 204 or the like to form a metal product 223; and repeats melting and forming the metal, while moving in the radial direction. Thus, one layer of the outer core 108K is formed. Next, the apparatus 200 moves in Z direction, and similarly repeats supplying, melting, and forming the metal powder with the same configuration on the one layer, and repeats these steps to stack in a desired axial direction, thus forming the outer core 108K. Finally, the winding 109 is wound around the protrusion 122K, and thus, the stator 103K is configured.

Similarly, the rotors and the stators according to the other embodiments and examples can also be configured using the AM.

Thus using the AM, it is possible to configured the inner core and the outer core such that materials having different magnetic characteristics are adjacent to each other in directions perpendicular to the rotating shaft 106. Using the AM, it is possible to firmly form a core in which different magnetic material portions are connected, as compared with the case of using electrical steel sheets.

In addition, by using the AM to simultaneously and integrally form the magnet 105 as well as the inner core 104, it is possible to further improved the mechanical strength of the rotor 102.

In addition, the method for forming the inner core and the outer core is not limited to the direct energy deposition as described above, and the inner core and the outer core may be formed using different methods depending on materials and applications.

### Other Embodiments

The disclosed embodiments and modified embodiments may be combined in an appropriate manner. For example, the motors according to the third to fifth embodiments may be combined with any configuration according to the first, second, and sixth embodiments and modified embodiments thereof in an appropriate manner.

The jointing method of FIG. 12 is also applicable to fitting of the yoke 111 and the high saturation magnetic flux density portions 112 of FIG. 2, and also applicable to fitting of the protrusions 122 and the high saturation magnetic flux density portions 123 of FIG. 9.

The described embodiments are applicable not only to a motor, but also to other rotating electrical machines, such as a generator.

As described above, according to the present embodiments, at least one of the inner core and the outer core has the high saturation magnetic flux density portions with a high cobalt content rate, at positions of a high magnetic flux density, and has the yoke containing iron as a main component and having good mechanical characteristics, at the other positions. As a result, it is possible to increase the magnetic flux density generated by the magnets, and achieve a high torque, while reducing usage of expensive materials including rare metals as much as possible. In addition, it is possible to generate the same torque as the prior art with a smaller current than the prior art. Further, in a case of generating the same torque as the prior art with the same current as the prior art, it is possible to reduce the thicknesses of the inner core and the outer core in the axial direction as compared with the prior art, and reduce the size of the rotating electrical machine as compared with the prior art.

### Summary Of Embodiments

Rotating electrical machines and methods of manufacturing the same according to various aspects of the present disclosure are configured as follows.

A rotating electrical machine of a first aspect of the present disclosure is provided with: a first magnetic core and a second magnetic core formed to be relatively rotatable with respect to each other about a common rotating shaft; a plurality of magnets provided in the first magnetic core; and a plurality of windings wound around the second magnetic core. At least one of the first magnetic core and the second magnetic core includes a plurality of magnetic material portions made of a plurality of magnetic materials having magnetic characteristics different from each other, respectively, in a cross section perpendicular to the rotating shaft.

According to a rotating electrical machine of a second aspect of the present disclosure, the rotating electrical machine of the first aspect may be configured as follows. The plurality of magnetic material portions includes a first magnetic material portion made of a first magnetic material having a first saturation magnetic flux density, and a second magnetic material portion made of a second magnetic material having a second saturation magnetic flux density higher than the first saturation magnetic flux density.

According to a rotating electrical machine of a third aspect of the present disclosure, the rotating electrical machine of the second aspect may be configured as follows. The first magnetic material contains iron as a main component. The second magnetic material contains cobalt at a content rate higher than a cobalt content rate of the first magnetic material.

According to a rotating electrical machine of a fourth aspect of the present disclosure, the rotating electrical machine of the second or third aspect may be configured as follows. The first magnetic core includes the first magnetic material portion and the second magnetic material portion. In the first magnetic core, the second magnetic material portion is provided such that the magnets are opposed to the second magnetic core via the second magnetic material portion.

According to a rotating electrical machine of a fifth aspect of the present disclosure, the rotating electrical machine of the second or third aspect may be configured as follows. The second magnetic core includes the first magnetic material portion and the second magnetic material portion. The second magnetic core has a yoke, and a plurality of protrusions protruding from the yoke toward the first magnetic core, and the plurality of windings are wound around the plurality of protrusions, respectively. In the second magnetic core, the second magnetic material portion is provided on surfaces of the plurality of protrusions.

According to a rotating electrical machine of a sixth aspect of the present disclosure, the rotating electrical machine of the second or third aspect may be configured as follows. The second magnetic core includes the first magnetic material portion and the second magnetic material portion. The second magnetic core has a yoke, and a plurality of protrusions protruding from the yoke toward the first magnetic core, and the plurality of windings are wound around the plurality of protrusions, respectively. In the second magnetic core, the second magnetic material portion is provided at tips of the plurality of protrusions.

According to a rotating electrical machine of a seventh aspect of the present disclosure, the rotating electrical machine of the sixth aspect may be configured as follows. Each of the plurality of protrusions has a protrusion base and a protrusion end, the protrusion base being connected to the yoke and extending in a radial direction with respect to the rotating shaft, and the protrusion end being connected to a distal end of the protrusion base and extending in a circumferential direction with respect to the rotating shaft. In each of the plurality of protrusions, the protrusion end includes a first portion connected to the protrusion base and made of the second magnetic material.

According to a rotating electrical machine of an eighth aspect of the present disclosure, the rotating electrical machine of the seventh aspect may be configured as follows. In each of the plurality of protrusions, the protrusion base includes a second portion connected to the protrusion end and made of the second magnetic material.

According to a rotating electrical machine of a ninth aspect of the present disclosure, the rotating electrical machine of the seventh or eighth aspect may be configured as follows. In each of the plurality of protrusions, a length of the first portion in the circumferential direction is longer than a length of the protrusion base in the circumferential direction.

According to a rotating electrical machine of a tenth aspect of the present disclosure, the rotating electrical machine of one of the seventh to ninth aspects may be configured as follows. In the protrusion base, a content rate of the second magnetic material gradually decreases, and a content rate of the first magnetic material gradually increases, as a distance from the protrusion end increases.

According to a rotating electrical machine of an 11th aspect of the present disclosure, the rotating electrical machine of one of the seventh to tenth aspects may be configured as follows. In the protrusion end, a content rate of the second magnetic material gradually decreases, and a content rate of the first magnetic material gradually increases, as a distance from a center of the protrusion base increases.

According to a rotating electrical machine of a 12th aspect of the present disclosure, the rotating electrical machine of one of the first to 11th aspects may be configured as follows. The plurality of magnetic material portions includes a first magnetic material portion made of a first magnetic material having a first iron loss, and a third magnetic material portion made of a third magnetic material having a second iron loss lower than the first iron loss.

According to a rotating electrical machine of a 13th aspect of the present disclosure, the rotating electrical machine of the 12th aspect may be configured as follows. The first magnetic material contains iron as a main component.

The third magnetic material contains silicon at a content rate higher than a silicon content rate of the first magnetic material.

According to a rotating electrical machine of a 14th aspect of the present disclosure, the rotating electrical machine of the 12th or 13th aspect may be configured as follows. The second magnetic core includes the first magnetic material portion and the third magnetic material portion. The second magnetic core has a plurality of protrusions around which the plurality of windings are wound, respectively. In the second magnetic core, the third magnetic material portion is provided inside the plurality of protrusions and surrounded by the first magnetic material portion.

According to a rotating electrical machine of a 15th aspect of the present disclosure, the rotating electrical machine of one of the first to 14th aspect may be configured as follows. each of the first magnetic core and the second magnetic core has a plurality of magnetic sheets stacked in a direction of the rotating shaft.

According to a rotating electrical machine of a 16th aspect of the present disclosure, the rotating electrical machine of the 15th aspect may be configured as follows. Two magnetic material portions of the plurality of magnetic material portions, the two magnetic material portions being adjacent to each other in directions perpendicular to the rotating shaft, include a plurality of first magnetic sheets stacked in the direction of the rotating shaft to configure one of the two magnetic material portions, and a plurality of second magnetic sheets stacked in the direction of the rotating shaft to configure another of the two magnetic material portions. The first magnetic sheets and the second magnetic sheets are formed with contours varying periodically and complementarily in the direction of the rotating shaft, such that the two magnetic material portions are fitted to each other.

According to a rotating electrical machine of a 17th aspect of the present disclosure, the rotating electrical machine of the 16th aspect may be configured as follows. Each of the first magnetic sheets has a first thickness. Each of the second magnetic sheets has a second thickness. The first magnetic sheets and the second magnetic sheets are formed with contours varying periodically and complementarily per a least common multiple of the first thickness and the second thickness.

According to a rotating electrical machine of an 18th aspect of the present disclosure, the rotating electrical machine of the 15th aspect may be configured as follows. Two magnetic material portions of the plurality of magnetic material portions, the two magnetic material portions being adjacent to each other in directions perpendicular to the rotating shaft, are formed such that one of the two magnetic material portions can be inserted into another of the two magnetic material portions in the direction of the rotating shaft, and so as to prevent separation of the two magnetic material portions in directions perpendicular to the rotating shaft.

According to a rotating electrical machine of a 19th aspect of the present disclosure, the rotating electrical machine of one of the first to 14th aspect may be configured as follows. At least one of the first magnetic core and the second magnetic core is formed by additive manufacturing.

A method of manufacturing a rotating electrical machine of a 20th aspect of the present disclosure includes: forming a first magnetic core and a second magnetic core so as to be relatively rotatable with respect to each other about a common rotating shaft; providing a plurality of magnets in the first magnetic core; and winding a plurality of windings around the second magnetic core. The forming the first magnetic core and the second magnetic core includes stacking a plurality of magnetic sheets in a direction of the rotating shaft. At least one of the first magnetic core and the second magnetic core includes a plurality of magnetic material portions made of a plurality of magnetic materials having magnetic characteristics different from each other, respectively, in a cross section perpendicular to the rotating shaft.

A method of manufacturing a rotating electrical machine of a 21st aspect of the present disclosure includes: forming a first magnetic core and a second magnetic core so as to be relatively rotatable with respect to each other about a common rotating shaft; providing a plurality of magnets in the first magnetic core; and winding a plurality of windings around the second magnetic core. The forming the first magnetic core and the second magnetic core includes forming the first magnetic core and the second magnetic core by additive manufacturing. At least one of the first magnetic core and the second magnetic core includes a plurality of magnetic material portions made of a plurality of magnetic materials having magnetic characteristics different from each other, respectively, in a cross section perpendicular to the rotating shaft.

### INDUSTRIAL APPLICABILITY

The present disclosure is applicable to various rotating electrical machines, such as industrial servo motors, drive motors for electric vehicles or plug-in hybrid vehicles, generators, and the like.

### REFERENCE SIGNS LIST

101, 101A to 101K: motor
102, 102A, 102B, 102H, 102I, 102J: rotor
103, 103B, 103C, 103D, 103E, 103F, 103H to 103K: stator
104, 104A, 104B, 104H: inner core
105, 105H: magnet
106: rotating shaft
107: bearing
108, 108B, 108C, 108D, 108E, 108F, 108H, 108K: outer core
109, 109H: winding
110: housing
111, 111A: yoke
112, 112A: high saturation magnetic flux density portion
121, 121D, 121E, 121F: yoke
122, 122C, 122D, 122E, 122F, 122K, 122Ka to 122Kd: protrusion
123, 124: high saturation magnetic flux density portion
125 to 127: low iron-loss portion
131: yoke
132: protrusion
141: yoke
142: high saturation magnetic flux density portion
151, 151a, 151d: protrusion base
152, 152b, 152c, 152d: protrusion end
161, 161a to 161c: portion made of high saturation magnetic flux density material
162, 162b, 163: portion made of low saturation magnetic flux density material
164a, 164b: transition region
200: direct energy deposition apparatus
201, 202: nozzle
203: lens
204: laser beam
210: substrate
221, 222: metal powder
223: metal product

1. A rotating electrical machine comprising:
a first magnetic core and a second magnetic core formed to be relatively rotatable with respect to each other about a common rotating shaft;
a plurality of magnets provided in the first magnetic core; and
a plurality of windings wound around the second magnetic core,
wherein at least one of the first magnetic core and the second magnetic core includes a plurality of magnetic material portions made of a plurality of magnetic materials having magnetic characteristics different from each other, respectively, in a cross section perpendicular to the rotating shaft.

2. The rotating electrical machine as claimed in claim 1,
wherein the plurality of magnetic material portions includes a first magnetic material portion made of a first magnetic material having a first saturation magnetic flux density, and a second magnetic material portion made of a second magnetic material having a second saturation magnetic flux density higher than the first saturation magnetic flux density.

3. The rotating electrical machine as claimed in claim 2,
wherein the first magnetic material contains iron as a main component, and
wherein the second magnetic material contains cobalt at a content rate higher than a cobalt content rate of the first magnetic material.

4. The rotating electrical machine as claimed in claim 2,
wherein the first magnetic core includes the first magnetic material portion and the second magnetic material portion, and
wherein in the first magnetic core, the second magnetic material portion is provided such that the magnets are opposed to the second magnetic core via the second magnetic material portion.

5. The rotating electrical machine as claimed in claim 2,
wherein the second magnetic core includes the first magnetic material portion and the second magnetic material portion,
wherein the second magnetic core has a yoke, and a plurality of protrusions protruding from the yoke toward the first magnetic core, and the plurality of windings are wound around the plurality of protrusions, respectively, and
wherein in the second magnetic core, the second magnetic material portion is provided on surfaces of the plurality of protrusions.

6. The rotating electrical machine as claimed in claim 2,
wherein the second magnetic core includes the first magnetic material portion and the second magnetic material portion,
wherein the second magnetic core has a yoke, and a plurality of protrusions protruding from the yoke toward the first magnetic core, and the plurality of windings are wound around the plurality of protrusions, respectively, and
wherein in the second magnetic core, the second magnetic material portion is provided at tips of the plurality of protrusions.

7. The rotating electrical machine as claimed in claim 6,
wherein each of the plurality of protrusions has a protrusion base and a protrusion end, the protrusion base being connected to the yoke and extending in a radial direction with respect to the rotating shaft, and the protrusion end being connected to a distal end of the protrusion base and extending in a circumferential direction with respect to the rotating shaft, and
wherein in each of the plurality of protrusions, the protrusion end includes a first portion connected to the protrusion base and made of the second magnetic material.

8. The rotating electrical machine as claimed in claim 7,
wherein in each of the plurality of protrusions, the protrusion base includes a second portion connected to the protrusion end and made of the second magnetic material.

9. The rotating electrical machine as claimed in claim 7,
wherein in each of the plurality of protrusions, a length of the first portion in the circumferential direction is longer than a length of the protrusion base in the circumferential direction.

10. The rotating electrical machine as claimed in claim 7,
wherein in the protrusion base, a content rate of the second magnetic material gradually decreases, and a content rate of the first magnetic material gradually increases, as a distance from the protrusion end increases.

11. The rotating electrical machine as claimed in claim 7,
wherein in the protrusion end, a content rate of the second magnetic material gradually decreases, and a content rate of the first magnetic material gradually increases, as a distance from a center of the protrusion base increases.

12. The rotating electrical machine as claimed in claim 1,
wherein the plurality of magnetic material portions includes a first magnetic material portion made of a first magnetic material having a first iron loss, and a third magnetic material portion made of a third magnetic material having a second iron loss lower than the first iron loss.

13. The rotating electrical machine as claimed in claim 12,
wherein the first magnetic material contains iron as a main component, and
wherein the third magnetic material contains silicon at a content rate higher than a silicon content rate of the first magnetic material.

14. The rotating electrical machine as claimed in claim 12,
wherein the second magnetic core includes the first magnetic material portion and the third magnetic material portion,
wherein the second magnetic core has a plurality of protrusions around which the plurality of windings are wound, respectively, and
wherein in the second magnetic core, the third magnetic material portion is provided inside the plurality of protrusions and surrounded by the first magnetic material portion.

15. The rotating electrical machine as claimed in claim 1,
wherein each of the first magnetic core and the second magnetic core has a plurality of magnetic sheets stacked in a direction of the rotating shaft.

16. The rotating electrical machine as claimed in claim 15,
wherein two magnetic material portions of the plurality of magnetic material portions, the two magnetic material portions being adjacent to each other in directions perpendicular to the rotating shaft, include a plurality of first magnetic sheets stacked in the direction of the rotating shaft to configure one of the two magnetic material portions, and a plurality of second magnetic sheets stacked in the direction of the rotating shaft to configure another of the two magnetic material portions, and
wherein the first magnetic sheets and the second magnetic sheets are formed with contours varying periodically and complementarily in the direction of the rotating shaft, such that the two magnetic material portions are fitted to each other.

17. The rotating electrical machine as claimed in claim 16,
wherein each of the first magnetic sheets has a first thickness,
wherein each of the second magnetic sheets has a second thickness, and
wherein the first magnetic sheets and the second magnetic sheets are formed with contours varying periodically and complementarily per a least common multiple of the first thickness and the second thickness.

18. The rotating electrical machine as claimed in claim 15,
wherein two magnetic material portions of the plurality of magnetic material portions, the two magnetic material portions being adjacent to each other in directions perpendicular to the rotating shaft, are formed such that one of the two magnetic material portions can be inserted into another of the two magnetic material portions in the direction of the rotating shaft, and so as to prevent separation of the two magnetic material portions in directions perpendicular to the rotating shaft.

19. The rotating electrical machine as claimed in claim 1,
wherein at least one of the first magnetic core and the second magnetic core is formed by additive manufacturing.

20. A method of manufacturing a rotating electrical machine, including:
forming a first magnetic core and a second magnetic core so as to be relatively rotatable with respect to each other about a common rotating shaft;
providing a plurality of magnets in the first magnetic core; and
winding a plurality of windings around the second magnetic core,
wherein the forming the first magnetic core and the second magnetic core includes stacking a plurality of magnetic sheets in a direction of the rotating shaft, and
wherein at least one of the first magnetic core and the second magnetic core includes a plurality of magnetic material portions made of a plurality of magnetic materials having magnetic characteristics different from each other, respectively, in a cross section perpendicular to the rotating shaft.

21. A method of manufacturing a rotating electrical machine, including:
forming a first magnetic core and a second magnetic core so as to be relatively rotatable with respect to each other about a common rotating shaft;
providing a plurality of magnets in the first magnetic core; and
winding a plurality of windings around the second magnetic core,
wherein the forming the first magnetic core and the second magnetic core includes forming the first magnetic core and the second magnetic core by additive manufacturing, and
wherein at least one of the first magnetic core and the second magnetic core includes a plurality of magnetic material portions made of a plurality of magnetic materials having magnetic characteristics different from each other, respectively, in a cross section perpendicular to the rotating shaft.
